(19) United States
(12) Patent Application Publication
(10) Pub. No.: US 2015/0015384 A1
(43) Pub. Date: Jan. 15, 2015

(54) Object Detection Device

(71) Applicant: Hitachi Automotive System, Ltd., hitachinaka-shi, Ibaraki (JP)

(72) Inventors: Takeshi Shima, Tokyo (JP); Mirai Higuchi, Tokyo (JP); Haruki Matono, Tokyo (JP); Taisetsu Tanimichi, Hitachinaka (JP)

(21) Appl. No.: 14/379,711

(22) PCT Filed: Feb. 6, 2013
(86) PCT No.: PCT/JP2013/052653

§ 371 Date: Aug. 19, 2014

(30) Foreign Application Priority Data
Mar. 14, 2012 (JP) 2012-057632

(51) Int. Cl. G08G 1/16

(52) U.S. Cl. CPC G08G 1/16
USPC 340/435

(57) ABSTRACT

An object of the present invention is to attain an object detection device that enables tracking travel control that does not cause a driver to experience a feeling of discomfort. An object detection device 104 of the present invention is an object detection device 104 that detects a subject 102 in front of the host vehicle on the basis of an image in which outside of the vehicle is captured from imaging devices 105 and 106 mounted in the host vehicle 103, and detects a relative distance or a relative speed with respect to the subject 102, having a risk factor determination unit 111 that, on the basis of the image, determines whether or not there is a risk factor that is a travel risk for the host vehicle 103.

### TECHNICAL FIELD

The present invention relates to an object detection device that detects a preceding vehicle from image information of outside a vehicle for example.

### BACKGROUND ART

In order to realize the safe traveling of a vehicle, research and development has been carried out with regard to devices that detect dangerous events in the periphery of a vehicle, and automatically control the steering, acceleration, and braking of the vehicle in order to avoid a detected dangerous event, and such devices have already been mounted in some vehicles. Among such technology, Adaptive Cruise Control (ACC) with which a preceding vehicle is detected by means of sensors mounted in a vehicle and tracking travel is carried out so as to not collide with the preceding vehicle is effective in terms of improving the safety of the vehicle and improving convenience for the driver. In Adaptive Cruise Control (ACC), a preceding vehicle is detected by an object detection device, and control is carried out on the basis of the detection results thereof.

### CITATION LIST

### Patent Literatures

PTL 1: JP 2004-17763 A
PTL 2: Patent Application 2005-210895
PTL 3: JP 2010-128949 A

### Non-Patent Literatures

NPL 1: Yuji OTSUKA et al., “Development of Vehicle Detection Technology Using Edge-Pair Feature Space Method”, VIEW 2005, Vision Technology Implementation Workshop Proceedings, pp. 160-165, 2005
NPL 2: Tomokazu MITSUI, Yuji YAMAUCHI, Hironobu FUJIYOSHI, “Human Detection by Two-Stage AdaBoost Using Joint HOG Features”, The 14th Symposium of Sensing via Image Information, SSII08, IN1-06, 2008

### SUMMARY OF INVENTION

### Technical Problem

However, if uniform tracking travel control based on a preceding vehicle detection result is carried out regardless of situations in which the driver feels that there is some risk in order for the vehicle to be made to travel safely such as in places where the view in front of the host vehicle is poor such as before the top of a sloping rode and on a curve, and in cases where visibility is low due to rain and fog and so forth, the driver is liable to experience a feeling of discomfort.

The present invention takes the aforementioned point into consideration, and an object thereof is to provide an object detection device that enables tracking travel control that does not cause the driver to experience a feeling of discomfort.

### Solution to Problem

An object detection device of the present invention which solves the above-mentioned problem is an object detection device that detects a subject in front of a host vehicle on the basis of an image in which outside of the vehicle is captured from an imaging device mounted in the host vehicle, and detects a relative distance or a relative speed with respect to the subject, the object detection device includes a risk factor determination means that, on the basis of the image, determines whether or not there is a risk factor that is a travel risk for the host vehicle.

### Advantageous Effects of Invention

According to the present invention, when a subject is detected, it is determined on the basis of an image whether or not there is a risk factor that is a travel risk for the host vehicle; therefore, if the related detection result is used for tracking travel control, the acceleration and deceleration of the vehicle can be controlled with consideration being given to risk factors in the periphery of the host vehicle, and it becomes possible to perform vehicle control that is safer and has a sense of security.

### BRIEF DESCRIPTION OF DRAWINGS

FIG. 1 is a drawing depicting an overview of the present invention.

FIG. 2 is a drawing depicting the processing flow in a subject detection unit.

FIG. 3 is a drawing depicting the output content of vehicle region output processing.

FIG. 4 is a drawing depicting the processing flow of a reliability calculation unit.

FIG. 5 is a drawing depicting the processing flow of a risk factor determination unit.

FIG. 6 is a drawing depicting the content of processing with which the relative distance with a preceding vehicle is obtained.

FIG. 7 is a drawing depicting the content of front view determination processing.

### DESCRIPTION OF EMBODIMENT

The present embodiment is hereafter described in detail with reference to the drawings.

In the present embodiment, a description is given with respect to the case where the object detection device of the present invention is applied to a device that uses a video taken by a stereo camera mounted in a vehicle to detect a preceding vehicle.

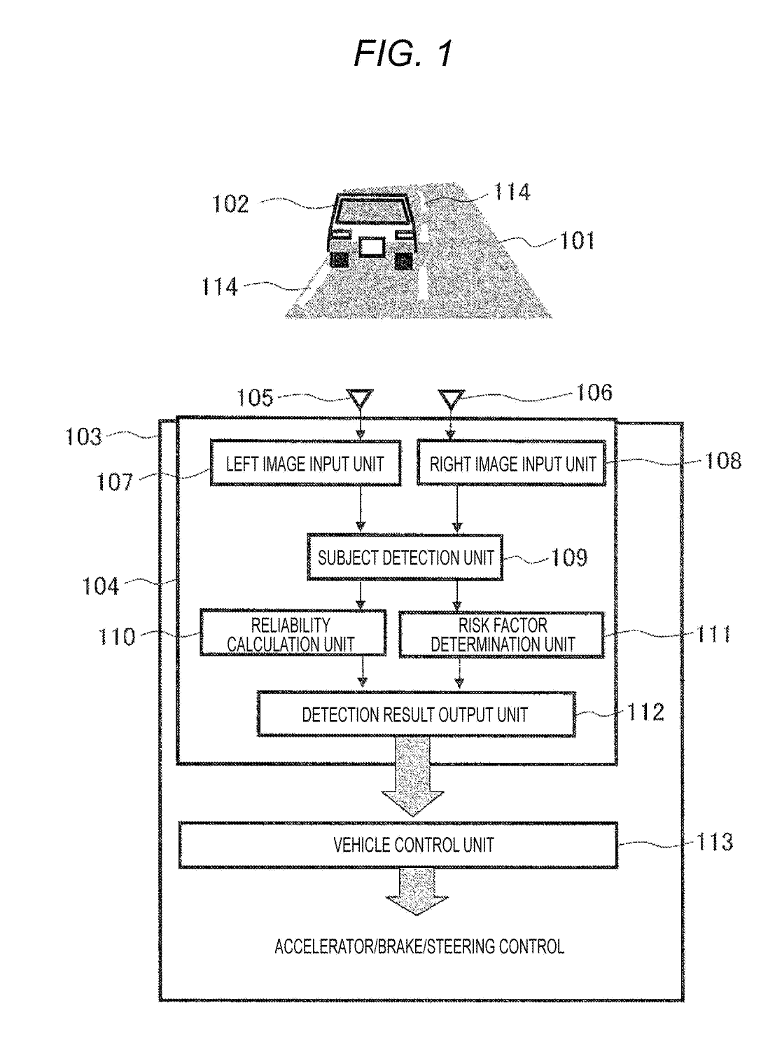

First, an overview of the vehicle system in the present embodiment is described using FIG. 1.

In FIG. 1, the reference sign 104 indicates a stereo camera device that is mounted in a vehicle (host vehicle) 103, detects the presence of a preceding vehicle 102 traveling in front of the vehicle 103, and calculates the relative distance or the relative speed from the vehicle 103 to be preceding vehicle 102.

The stereo camera device 104 has the two cameras of a left imaging unit 105 and a right imaging unit 106 that capture images of in front of the vehicle 103, left images captured by the left imaging unit 105 are input to a left image input unit 107, and right images captured by the right imaging unit 106 are input to a right image input unit 108.

A subject detection unit 109 searches within the left images that are input to the left image input unit 107, extracts portions in which the preceding vehicle 102 is captured, and at the same time, uses the amount of deviation in the images of the preceding vehicle 102 captured in the left images and the right images to calculate the relative distance or the relative speed from the vehicle 103 to the preceding vehicle 102. The details of the processing carried out by the subject detection unit 109 are described hereafter.

In a reliability calculation unit 110, the reliability regarding the detection result for the preceding vehicle 102 detected by the subject detection unit 109 is calculated. The details of the reliability calculation unit 110 are described hereafter.

In a risk factor determination unit 111 (risk factor determination means), it is determined whether or not there is a risk factor in the peripheral environment that is linked to a decrease in the reliability of the detection result when the preceding vehicle 102 is detected by the subject detection unit 109. Here, a risk factor is a travel risk for the host vehicle, and, for example, refers to factors such as whether or not water droplets and dirt are adhered to the windshield of the vehicle 103 or the lenses of the left and right imaging units 105 and 106 of the stereo camera device 104, whether or not the visibility in front of the vehicle 103 is poor due to fog, rainfall, or snowfall (poor visibility), and whether or not the road linear view (undulations and curves) in front of the vehicle 103 is poor. The details of the risk factor determination unit 111 are described hereafter.

In a detection result output unit 112, whether or not a preceding vehicle 102 has been detected by the subject detection unit 109, the relative distance/relative speed with the vehicle 103 (host vehicle), the reliability regarding the detection result of the preceding vehicle 102 calculated by the reliability calculation unit 110, and the risk factor determination result determined by the risk factor determination unit 111 are output. The details of the detection result output unit 112 are described hereafter.

In a vehicle control unit 113 of the vehicle 103, on the basis of the relative distance/relative speed with the preceding vehicle 102 calculated by the subject detection unit 109, the reliability regarding the detection result of the preceding vehicle 102 calculated by the reliability calculation unit 110, and the risk factor determination result determined by the risk factor determination unit 111, which are output results of the stereo camera device 104, an amount of accelerator control, an amount of brake control, and an amount of steering control for performing tracking travel with respect to the preceding vehicle 102 are calculated, and vehicle control such as the acceleration and deceleration of the vehicle 103 is performed.

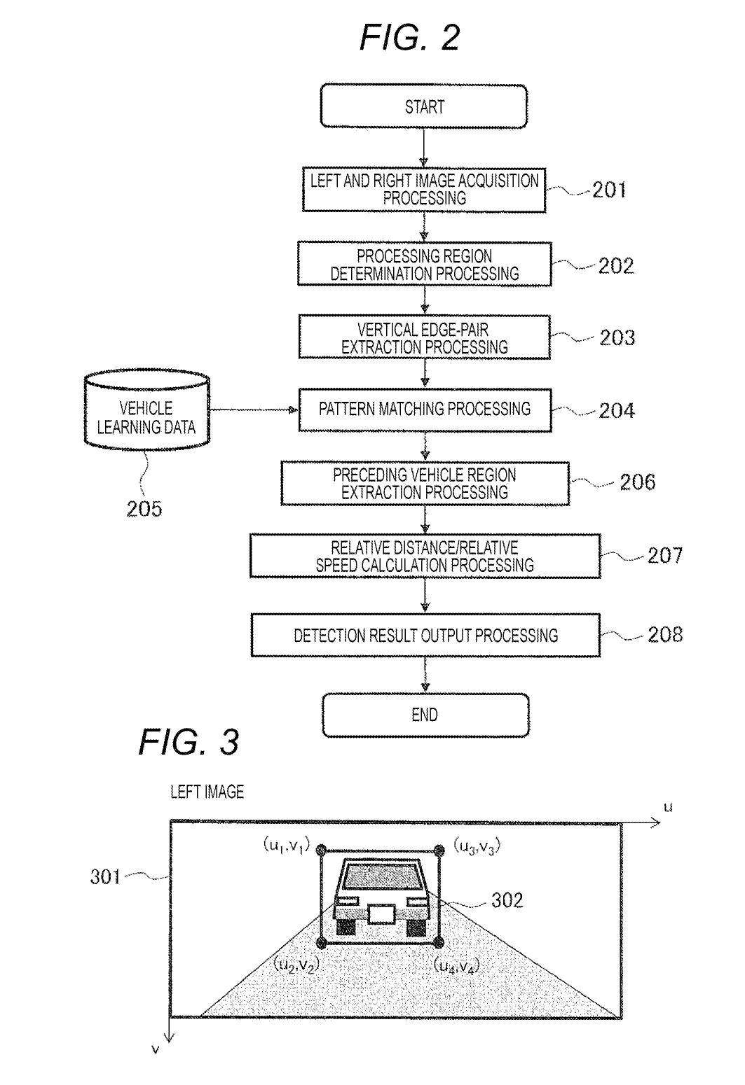

Next, the processing performed by the subject detection unit 109 of the stereo camera device 104 is described using FIG. 2. FIG. 2 is the processing flow performed by the subject detection unit 109. First, in left and right image acquisition processing 201, a left image captured by the left imaging unit 105 that is input to the left image input unit 107 of the stereo camera device 104, and a right image captured by the right imaging unit 106 that is input to the right image input unit 108 are acquired.

Next, in processing region determination processing 202, from among the left and right images acquired in the left and right image acquisition processing 201, a region in which processing to extract portions in which the preceding vehicle 102 has been captured from among the left and right images is determined. As one processing region determination method, for example, there is a method in which two lane boundary lines 114 on either side of the traveling lane of a road 101 along which the vehicle 103 travels are detected from within the left image captured by the left imaging unit 105, and the region between the two detected lane boundary lines 114 is set as the processing region.

Next, in vertical edge-pair extraction processing 203, a pair of vertical edges in which image brightness edge components are present as a pair in the vertical direction of the image are extracted within the image processing region determined in the processing region determination processing 202. In the extraction of the pair of vertical edges, processing is carried out to scan the image in the horizontal direction, and detect portions in which portions having an image brightness value gradient that is equal to or greater than a fixed threshold value are continuously present the vertical direction of the image.

Next, in pattern matching processing 204, the similarity of a brightness pattern with learning data 205 is calculated with respect to a rectangular region that encloses the pair of vertical edges extracted in the vertical edge-pair extraction processing 203, and it is determined whether the rectangular region is a portion in which the preceding vehicle 102 is captured. A technique such as a neural network and a support vector machine is used to determine the similarity. Furthermore, with regard to the learning data 205, a large number of positive data images in which the rear surfaces of a variety of preceding vehicles 102 are captured in advance, and a large number of negative data images in which photographic subjects that are not the rear surfaces of preceding vehicles 102 are captured are prepared.

Next, in preceding vehicle region extraction processing 206, coordinate values (u₁, v₁), (u₁, v₂), (u₂, v₁), and (u₂, v₂) of a rectangular region (302 in FIG. 3) within an image in which the degree of similarity with the preceding vehicle 102 is equal to or greater than a certain fixed threshold value according to the pattern matching processing 204 are output.

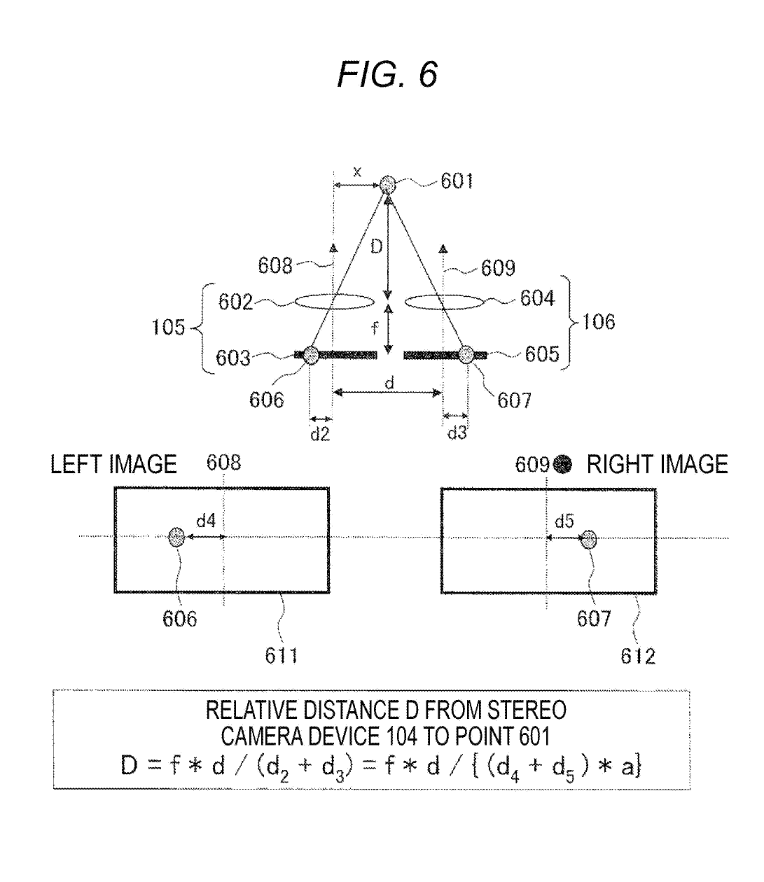

Next, in relative distance/relative speed calculation processing 207, the relative distance or the relative speed between the preceding vehicle 102 in the region extracted in the preceding vehicle region extraction processing 206 and the vehicle 103 is calculated. The method for calculating the relative distance from the stereo camera device 104 to a detection subject is described using FIG. 6. FIG. 6 illustrates a method for calculating the distance from a camera of a corresponding point 601 (the same object captured by left and right cameras) in a left image 611 and a right image 612 taken by the stereo camera device 104.

In FIG. 6, the left imaging unit 105 is a camera having a focal distance f and an optical axis 608 formed of a lens 602 and an imaging surface 603, and the right imaging unit 106 is a camera having the focal distance f and an optical axis 609 formed of a lens 604 and an imaging surface 605. The point 601 in front of the cameras is captured at point 606 (at the distance of d₂ from the optical axis 608) in the imaging surface 603 of the left imaging unit 105, and is the point 606 (the position of the d₄ pixel from the optical axis 608) in the left image 611. Likewise, the point 601 in front of the cameras is captured at point 607 (at the distance of d₃ from the optical axis 609) in the imaging surface 605 of the right imaging unit 106, and is the point 607 (the position of the d₅ pixel from the optical axis 609) in the right image 612.

In this way, the point 601 of the same object is captured at the position of the d₄ pixel to the left from the optical axis 608 in the left image 611, and in the position of d₅ to the right from the optical axis 609 in the right image 612, and a parallax of the d₄+d₅ pixels is generated. Therefore, if the distance between the optical axis 608 of the left imaging unit 105 and the point 601 is taken as x, the distance D from the stereo camera device 104 to the point 601 can be obtained by means of the following expression.

From the relationship between the point 601 and the left imaging unit 105 d₂:f=x:D

From the relationship between the point 601 and the right imaging unit 106 d₃:f=(d−x):D

D=f×d/(d₂+d₃)=f×d/{(d₄+d₅)×a} is therefore established. Here, a is the size of the imaging elements of the imaging surfaces 603 and 605.

With regard to calculating the relative speed from the stereo camera device 104 to the detection subject, the relative speed is obtained by taking the time-sequential differential values of relative distances to the detection subject previously obtained.

Lastly, in detection result output processing 208, data regarding the vertical edges extracted in the vertical edge-pair extraction processing 203, data regarding the values determined in the pattern matching processed in the pattern matching processing 204, and the relative distance/relative speed to the preceding vehicle calculated in the preceding vehicle region extraction processing 206 are output.

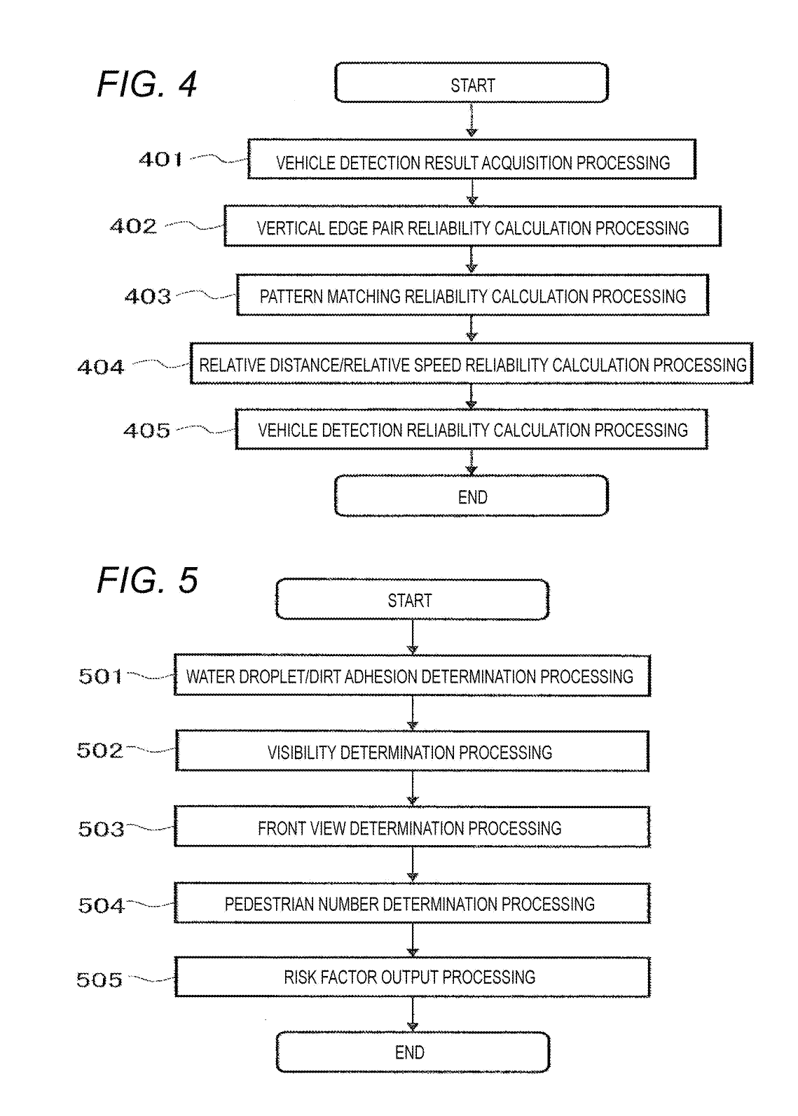

Next, the processing performed in the reliability calculation unit 110 is described using FIG. 4. FIG. 4 is the processing flow performed by the reliability calculation unit 110.

First, in vehicle detection result acquisition processing 401, data that is output in the detection result output processing 208 performed by the subject detection unit 109 is acquired. The acquired data is data regarding the vertical edges extracted in the vertical edge-pair extraction processing 203, data regarding the values determined in the pattern matching processed in the pattern matching processing 204, and the relative distance/relative speed to the preceding vehicle calculated in the preceding vehicle region extraction processing 206.

Next, in vertical edge pair reliability calculation processing 402, the data regarding the vertical edges extracted in the vertical edge-pair extraction processing 203 from among the data acquired in the vehicle detection result acquisition processing 401 is used to calculate the reliability regarding the detection of the pair of vertical edges that have been detected. The data regarding the vertical edges is the average value of the brightness gradient values when the vertical edges are extracted, and the voting value when the pair is calculated. The voting value is a value obtained by carrying out voting at a position in Hough space corresponding to the center position of two vertical edges (e.g., see NPL 1).

Here, the value of the total of the average value of the brightness gradient values of the vertical edges when the preceding vehicle 102 is most clearly captured and the voting value when the pair is calculated is taken as a, and the value obtained by dividing the total of the average value of the brightness gradient values of the vertical edges detected and the voting value when the pair is calculated is taken as the reliability of the pair of vertical edges.

Next, in pattern matching reliability calculation processing 403, the data regarding the values determined in the pattern matching processed in the pattern matching processing 204 from among the data acquired in the vehicle detection result acquisition processing 401 is used to calculate the reliability regarding the vehicle region detected. The data regarding the values determined in the pattern matching is the degree of similarity when the similarity of the brightness pattern with the learning data 205 is calculated with respect to a rectangular region that is enclosed by the two vertical edges extracted in the vertical edge-pair extraction processing 203.

Here, the degree of similarity when the preceding vehicle 102 is most clearly captured is taken as b, and the value obtained by dividing the degree of similarity between the rectangular region enclosed by the two vertical edges and the learning data by b is taken as the pattern matching reliability.

Next, in relative distance/relative speed reliability calculation processing 404, deviation in the relative distance/relative speed to the preceding vehicle calculated in the preceding vehicle region extraction processing 206 from among the data acquired in the vehicle detection result acquisition processing 401 is used to calculate the reliability regarding the relative distance/relative speed calculated.

Here, the relative speed and relative distance are, time-sequential variance values of values from a point in time in the past to the present are calculated, the variance values of the relative distance and the relative speed when the preceding vehicle 102 has been captured in the most stable manner are taken as c and d respectively, the inverse of the value obtained by dividing the calculated relative distance variance value by c is taken as the reliability regarding the relative distance, and the inverse of the value obtained by dividing the calculated relative speed variance value by d is taken as the reliability regarding the relative speed.

In vehicle detection reliability calculation processing 405, the product of all of the reliabilities calculated in each of the vertical edge-pair reliability calculation processing 402, the pattern matching reliability calculation processing 403, and the relative distance/relative speed reliability calculation processing is calculated and taken as the vehicle detection reliability.

Next, the processing performed in the risk factor determination unit 111 is described using FIG. 5. FIG. 5 is the processing flow performed by the risk factor determination unit 111.

First, in water droplet/dirt adhesion determination processing 501, it is determined whether or not water droplets and dirt are adhered to the windshield of the vehicle 103 and to the lenses of the left and right imaging units 105 and 106 of the stereo camera device 104. The stereo camera device 104 is installed in the vehicle, and determines whether or not water droplets and dirt are adhered to the windshield when capturing images of in front of the vehicle through the windshield.

With regard to determining the adhesion of water droplets, data of a windshield raindrop sensor mounted in the vehicle 103 is acquired or, alternatively, LED light is irradiated onto the windshield from an LED light irradiation device mounted in the stereo camera device 104, scattered light produced by water droplets is detected by the stereo camera device 104, and it is determined that water droplets are adhered if scattered light is detected. At such time, the degree of scattering of the scattered light is output (degree of risk calculation means) as the degree of water droplet adhesion (degree of risk).

Furthermore, with regard to determining the adhesion of dirt, the differences between the pixels of the entirety of the image for the image at the present point in time and the image of the immediately preceding frame are calculated with regard to images captured by the left imaging unit 105 of the stereo camera device 104, the accumulation of those difference values from a point in time in the past to the present point in time is taken, and it is determined that dirt is adhered to the windshield if the pixels of a portion in which the cumulative value of the difference values is equal to or less than a predetermined threshold value occupy a certain fixed area or more. At such time, the area value of the portion in which the cumulative value of the difference values is equal to or less than the threshold value is output (degree of risk calculation means) as the degree of dirt adhesion (degree of risk).

Furthermore, if the stereo camera device 104 is installed outside of the vehicle, it is determined whether or not water droplets are adhered to the lenses of the left imaging unit 105 and the right imaging unit 106 of the stereo camera device 104.

With regard to determining the adhesion of water droplets, for example, with respect to images captured by the left imaging unit 105 of the stereo camera device 104, brightness edges for the entirety of the images are calculated, the values of the gradients of those brightness edges are accumulated from a point in time in the past to the present point in time, and it is determined that water droplets are adhered if pixels in which the cumulative value is equal to or greater than a predetermined threshold value occupy a certain fixed area or more. At such time, the area value of the portion in which the cumulative value of the brightness edges gradients is equal to or greater than the threshold value is output (degree of risk calculation means) as the degree of water droplet adhesion (degree of risk). With regard to determining the adhesion of dirt on a lens, a detailed description thereof is omitted as it is the same as the method for determining whether dirt is adhered on the windshield.

Next, in visibility determination processing 502, it is determined whether or not the visibility in front of the vehicle 103 is poor due to fog, rainfall, or snowfall (poor visibility). In order to determine the visibility, for example, an image region having a fixed area in which the road 101 is captured, among the images captured by the left imaging unit 105 of the stereo camera device 104, is extracted. Then, if the average value of the brightness values of the pixels within a rectangle are equal to or greater than a predetermined threshold value, it is determined that the road surface appears white due to fog, rainfall, or snowfall, and that the visibility is poor. Furthermore, at such time, the deviation from the predetermined threshold value is calculated with regard to the average value of the brightness values obtained within the rectangle, and the value of the deviation is output (degree of risk calculation means) as the visibility (degree of risk).

Next, in front view determination processing 503, it is determined whether or not the road linear view (undulations and curves) in front of the vehicle 103 is poor. First, with regard to road undulations, it is determined whether or not in front of the vehicle is near the top of a slope. For this purpose, the vanishing point position of the road 101 is obtained from within an image captured by the left imaging unit 105 of the stereo camera device 104, and it is determined whether or not the vanishing point is in a blank region.

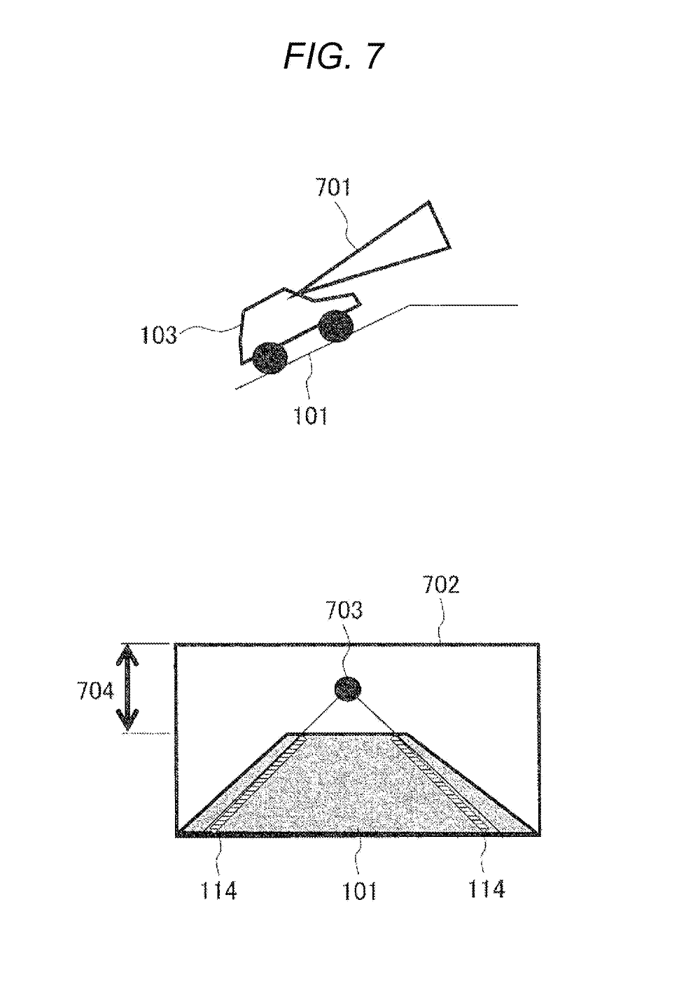

In FIG. 7, reference sign 701 indicates the field of view from the stereo camera device 104 when the vehicle 103 is traveling before the top of an upward gradient, and as a result, an image captured by the left imaging unit 105 of the stereo camera device 104 is similar to image 702. The lane boundary lines 114 of the road 101 are detected from the image 702, and the plurality of lane boundary lines are extended and point 703 where the lane boundary lines intersect is obtained as the vanishing point.

Meanwhile, in the upper section in the image 702, edge components are detected, and a region in which the amount of edge components is equal to or less than a predetermined threshold value is determined as a blank region 704. Then, if the previously obtained vanishing point 703 is present within the blank region 704, it is determined that the vehicle 103 is traveling near the top of a slope having an upward gradient. At such time, the proportion of the blank region 704 that closes in the image vertical direction is output (degree of risk calculation means) as the degree of closeness to the top of a slope (degree of risk). In other words, if the proportion of the blank region 704 that closes in the image vertical direction is small, this means that the degree of closeness to the top of a slope is low, and if the proportion of the blank region 704 that closes in the image vertical direction is large, this means that the degree of closeness to the top of a slope is high.

With regard to a curve in the road, by means of the method disclosed in PTL 3 for example, the shape of the road in front of the vehicle 103 can be detected using the stereo camera device 104, and it can be determined whether or not a curve is present in front of the vehicle 103. Here, the information of a three-dimensional object in front of the vehicle 103 used when determining the shape of the curve is used to calculate the distance to the three-dimensional object along the curve, and that distance is taken as the distance to the curve.

Next, in pedestrian number determination processing 504, the number of pedestrians that are present in front of the vehicle 103 is detected. The detection of the number of pedestrians is carried out using an image captured by the left imaging unit 105 of the stereo camera device 104, and is carried out using the known technology disclosed in NPL 2, for example. Then, it is determined whether or not the number of pedestrians detected is greater than a preset threshold value. Furthermore, the ratio of the number of pedestrians detected and the threshold value is output (degree of risk calculation means) as the degree of the number of pedestrians (degree of risk) it should be noted that, apart from people who are walking, people who are standing still and people who are riding bicycles are also included in these pedestrians.

Lastly, in risk factor output processing 505, the content determined in water droplet/dirt adhesion determination processing 501, visibility determination processing 602, front view determination processing 503, and pedestrian number determination processing 504 is output. Specifically, information on whether or not water droplets are adhered and the degree of adhesion thereof, and whether or not dirt is adhered and the degree of adhesion thereof are output from the water droplet/dirt adhesion determination processing 501, and information on visibility is output from the visibility determination processing 502. Then, information on whether or not the vehicle is near the top of a slope having an upward gradient and the degree of closeness to the top of the slope, and information on whether or not there is a curve in front of the vehicle and the distance to the curve are output from the front view determination processing 503. Then, information on the number of pedestrians that are present in front of the vehicle and the degree thereof is output from the pedestrian number determination processing 504.

Next, the processing performed by the detection result output unit 112 of the stereo camera device 104 is described. Here, information on whether or not a preceding vehicle 102 has been detected by the subject detection unit 109, the relative distance and relative speed to the preceding vehicle 102, the reliability of a detected subject calculated by the reliability calculation unit 110, and the risk factor determination result determined by the risk factor determination unit 111 are output from the stereo camera device 104.

Whether or not there is a risk factor and the degree of the risk factor are included in the information of the risk factor determination result, and, specifically, whether or not water droplets are adhered and the degree of adhesion thereof, whether or not dirt is adhered and the degree of adhesion thereof, the visibility in front of the vehicle, whether or not the vehicle is near the top of a slope having an upward gradient and the degree of closeness to the top of the slope, whether or not there is a curve in front of the vehicle and the distance to the curve, and the number of pedestrians and the degree thereof are included. It should be noted that these risk factors are examples, and other risk factors may be included, and, furthermore, it is not necessary for all of these to be included, and at least one ought to be included.

Next, the processing performed by the vehicle control unit 113 mounted in the vehicle 103 is described. Here, whether or not there is a preceding vehicle 102 and the relative distance or the relative speed to the preceding vehicle 102 is used from among the data output from the detection result output unit 112 of the stereo camera device 104 to calculate an amount of accelerator control and an amount of brake control such that tracking travel is carried out without colliding with the preceding vehicle 102.

Furthermore, at such time, from among the data output from the detection result output unit 112, if the reliability of the detected subject is equal to or greater than a predetermined threshold value, the amount of accelerator control and the amount of brake control for performing tracking travel with respect to the preceding vehicle are calculated, and if the reliability of the detected subject is equal to or less than the threshold value, vehicle control is not performed, the possibility of a vehicle being present in front of the driver is displayed in a meter portion, and the attention of the driver is drawn to the front.

Thus, even if the reliability of the detected preceding vehicle 102 is low, and it is not a state in which control for performing tracking travel without the vehicle 103 colliding with the preceding vehicle 102 is able to be performed, at the same time as drawing the attention of the driver to the front, the driver is able to grasp that the system is in a state in which a preceding vehicle 102 is being detected, and it becomes possible to perform vehicle control that is safer and has a sense of security.

Furthermore, if a preceding vehicle 102 is not present, from among the data detected from the detection result output unit 112, whether or not water droplets or dirt is adhered and when the degree of adhesion thereof is equal to or greater than a predetermined threshold value, when the visibility in front of the vehicle is equal to or less than a predetermined threshold value, when the degree of closeness to the top of a slope is equal to or greater than a predetermined threshold value, when the distance to a curve in front is equal to or less than a predetermined threshold value, and when the number of pedestrians is equal to or greater than a predetermined threshold value, brake control for the vehicle is carried out, and the vehicle is decelerated to a predetermined vehicle speed.

Thus, even if a preceding vehicle 102 is present, the speed of the vehicle is decreased in advance in situations in which the stereo camera device 104 is not able to detect a preceding vehicle 102.

In this way, by carrying out acceleration/deceleration control for the vehicle with consideration being given to the reliability of the detection subject output from the stereo camera device and peripheral risk factors, the risk of colliding with the preceding vehicle 102 is reduced, and it becomes possible to perform vehicle control that is safer and has a sense of security.

### REFERENCE SIGNS LIST

101 road
102 preceding vehicle (subject)
103 vehicle (host vehicle)
104 stereo camera device
105 left imaging unit (imaging device)
106 right imaging unit (imaging device)
109 subject detection unit
110 reliability calculation unit
111 risk factor determination unit (risk factor determination means)
112 detection result output unit
113 vehicle control unit

1. An object detection device that detects a subject in front of a host vehicle on the basis of an image in which outside of the vehicle is captured from an imaging device mounted in the host vehicle, and detects a relative distance or a relative speed with respect to the subject,
comprising a risk factor determination means that, on the basis of the image, determines whether or not there is a risk factor that is a travel risk for the host vehicle.

2. The object detection device according to claim 1, wherein the risk factor determination means includes a water droplet/dirt adhesion determination processing means that determines, based on the image, whether or not at least one of water droplets and dirt is adhered to at least one of a lens of the imaging device and a windshield.

3. The object detection device according to claim 1, wherein the risk factor determination means includes a visibility determination processing means that determines whether or not visibility is poor on the basis of a brightness value of an image region of a road surface included in the image.

4. The object detection device according to claim 1, wherein the risk factor determination means includes a view determination processing means that determines whether or not a view in front is poor on the basis of a road shape in front of the vehicle obtained from the image.

5. The object detection device according to claim 1, wherein the risk factor determination means includes a pedestrian number determination processing means that determines whether or not traveling is easy on the basis of the number of pedestrians in front of the vehicle obtained from the image.

6. The object detection device according to claim 1, wherein the risk factor determination means includes a risk degree calculation means that calculates the degree of the risk factor on the basis of the image.

7. The object detection device according to claim 6, wherein the risk degree calculation means calculates the degree of adhesion for the water droplets/dirt.

8. The object detection device according to claim 6, wherein the risk degree calculation means calculates the visibility in front of the host vehicle.

9. The object detection device according to claim 6, wherein the risk degree calculation means calculates the degree of the view in front of the host vehicle.

10. The object detection device according to claim 9, wherein the risk degree calculation means calculates a distance to a curve in front of the host vehicle as the degree of view.

11. The object detection device according to claim 9, wherein the risk degree calculation means calculates a distance to the top of an upward slope in front of the host vehicle as the degree of view.

12. The object detection device according to claim 1, comprising a reliability calculation means that calculates the reliability of the detection of the subject on the basis of the image.
